(19) United States
(12) Patent Application Publication
(10) Pub. No.: US 2003/0216992 A1
(43) Pub. Date: Nov. 20, 2003

(54) Integrated method of exchanging goods electronically

(76) Inventor: Mustafa Erhan Say, Istanbul (TR)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/146,163

(22) Filed: May 15, 2002

(51) Int. Cl. G06F 17/60

(52) U.S. Cl. 705/37

(57) ABSTRACT

A method is provided for auctioning products or services, comprising the steps of: sending a request, from an organizer, the request comprising one or more product specification terms, quantity terms, shipment terms, and payment terms; in response to the request, receiving one or more proposals, each proposal comprising the shipment terms, quantity terms, and payment terms; converting the received shipment terms, quantity terms, and payment terms into a normalized shipment term, quantity term, and payment term, respectively; based on the normalized shipment term, quantity term, and payment term, accepting a plurality of bids from one or more bidders; and selecting one or more of the bids. A method is also provided for auctioning products or services, the method comprising the steps of: setting the terms of a contract such as contract duration, contract starting month, total contract quantity, number of shipments per month, contract price basis where price basis is determined as fixed price or a formulate related price with a reference to a publication or producer with further specifications; specifying a shipment schedule, the shipment schedule comprising a shipment month, a number of shipments within that month, a quantity per shipment and an expected shipment timing

### FIELD OF THE INVENTION

The present invention relates to a method of buying and selling goods. Specifically, the present invention relates to buying and selling goods in an auction transaction.

### BACKGROUND INFORMATION

The Internet, a network connecting many computer networks and based on a common addressing system and communications protocol called TCP/IP (Transmission Control Protocol/Internet Protocol), has revolutionized the computer and communications world like nothing before. From its creation in 1983 it grew rapidly beyond its largely academic origin into an increasingly commercial and popular medium.

By the mid-1990s the Internet connected millions of computers throughout the world. Many commercial computer network and data services also provided at least indirect connection to the Internet.

The original uses of the Internet were electronic mail (commonly called “E-mail”), file transfer (using ftp, or file transfer protocol), bulletin boards and newsgroups, and remote computer access (telnet). The World Wide Web, which enables simple and intuitive navigation of Internet sites through a graphical interface, expanded dramatically during the 1990s to become the most important component of the Internet.

The Internet had its origin in a U.S. Department of Defense program called ARPANET Advanced Research Projects Agency Network), established in 1969 to provide a secure and survivable communications network for organizations engaged in defense-related research. Researchers and academics in other fields began to make use of the network, and at length the National Science Foundation (NSF), which had created a similar and parallel network called NSFNet, took over much of the TCP/IP technology from ARPANET and established a distributed network of networks capable of handling far greater traffic. NSF continues to maintain the backbone of the network (which carries data at a rate of 45 million bits per second), but Internet protocol development is governed by the Internet Architecture Board, and the InterNIC (Internet Network Information Center) administers the naming of computers and networks.

Amateur radio, cable television wires, spread spectrum radio, satellite, and fibre optics all have been used to deliver Internet services. Networked games, networked monetary transactions, and virtual museums are among applications being developed that both extend the network's utility and test the limits of its technology.

In recent years, it has also become increasingly common to have auctions over the Internet, with the buyer using credit cards or other forms of credit to purchase the goods auctioned.

### SUMMARY OF THE INVENTION

A computerized method for auctioning products or services according to an embodiment of present invention is provided. A request is sent from an organizer. The request comprises one or more product specification terms, quantity terms, shipment terms, payment terms and other terms that are relevant to the organizer's line of business or practices. In response to the request, one or more proposals are received. Each proposal comprises the product specifications, shipment terms, quantity terms, payment terms and other terms that are relevant to the organizer's line of business or practices. The received proposals are then normalized by using a normalization value. A plurality of offers from one or more participants are accepted. One or more of the offers is selected from one participant. Accepted offers place price bids during the Bid Event. Additional steps are also provided according to an embodiment of the present invention. Three or less bidders can be selected based on their bids and invited to negotiate further. A counter-offer is sent to each of the bidders, the counter-offer comprising the shipment terms, quantity terms, payment terms, and a price. A counter-reply is received. The counter-reply comprises the shipment terms, quantity terms, payment terms, and the price.

A method for auctioning products or services according to another embodiment of the present invention is also provided. Contract terms including contract duration, contract starting month, total contract quantity, number of shipments per month, contract price basis are specified. Contract price basis can be specified as fixed price or a formulate related price with a reference to a publication or producer with further specifications. A shipment schedule is specified. The shipment schedule comprises a shipment month, number of shipments within that month, the quantity per shipment and expected shipment timing. The quantity per shipment field and expected shipment timing field are configurable by a user.

### BRIEF DESCRIPTION OF THE DRAWINGS

FIG. 1 shows a an embodiment according to the present invention.

FIG. 2 shows a detailed flow chart for an embodiment according to the present invention.

FIG. 3 shows the bidding process for the contract Bid Event.

FIG. 4 shows a flow chart for the creation of the Bid Event for contract purchases.

FIG. 5 shows a display screen.

### DETAILED DESCRIPTION OF THE PREFERRED EMBODIMENTS

In certain embodiments according to the present invention a method that uses four modules to perform an auction is provided. An organizer sends a request comprising one or more product specification terms, quantity terms, shipment terms, and payment terms is sent. In response to the request, one or more proposals are received from one or more participants. The proposals are converted into a normalized term. Based on the normalized term, one or more of the participants (e.g., bidders) are accepted. Then, bids are resubmitted by the selected participants until one is selected.

The Organizer can be a company or individual who uses the system to purchase or sell goods either by creating an auction. The auction can be created by a Bid Event for contract purchases or by creating a “Request for Proposal with different transacting alternatives followed by a “Proposal Collection”, “Proposal Normalization” and “Invitation to Bid” (explained below). In case of Bid Event for contract purchases, participants or bidders are those companies that the organizer invites to the Bid Event. In the other cases, participants are companies invited by the organizer to make proposals in response to his request.

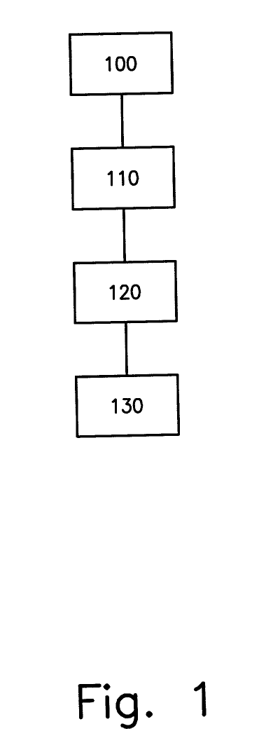

FIG. 1 shows an embodiment according to the present invention. A “Bid Event” for one or more products is conducted. The organizer decides whether he wants to create a Bid Event for contract purchases/sales or a Request for proposal with different transacting alternatives followed by a Bid Event. In case of the latter, the Bid Event is set up by an organizer who specifies the product being purchased/sold in a proposal. Then, one or more sellers/buyers(participants) respond to the proposal. If the organizer accepts the proposal, the participant is invited to bid in a “Bid Event”. The organizer can then select one or more of the bids. Preferably, the “Bid Event” is handled by a first, second, third, and fourth module 100,110,120,130. The first module 100 comprises functionality for scheduling the Bid Event. The second module 110 comprises functionality for preparing the Bid Event. The third module 120 comprised functionality for starting the Bid Event, and the fourth module 130 comprises functionality for closing the Bid Event. Preferably, the products are raw materials used in metal manufacture (e.g. scrap or basic pig iron), semi-finished products (e.g., slab or billet), long products (e.g., wire rods or reinforcing bars), or flat rolled products (e.g., hot rolled or cold rolled). However, it should be understood to one skilled in the arts that the modules 100,110,120,130 can be applied to other industries.

At first module 100, the organizer sets up a Bid Event for the second module 120. Also, at the first module 100, a Request for proposal with transacting alternatives is created. This Request for proposal enables the organizer to ask proposals from invited participants in response to his request which includes information about the product, payment, shipment terms and also details about the Bid Event. Proposal Collection allows the participants to send their proposal or proposals to the organizer at the second module 110. Preferably, the second module 110 executes 24 hours before the third module 120 (e.g., the time when the Bid Event starts). The proposals made may vary from the specifications declared by the organizer. In case there are differences between the proposals and the request made by the organizer, the organizer needs to normalize the proposals so that the bids can be leveled during the bidding and a feedback can be made to the bidders as to their current position. When the Bid Event end, the fourth module 130 allows for the transacting alternative (e.g., a Multi-party concurrent negotiation) preferred by the Organizer to take place.

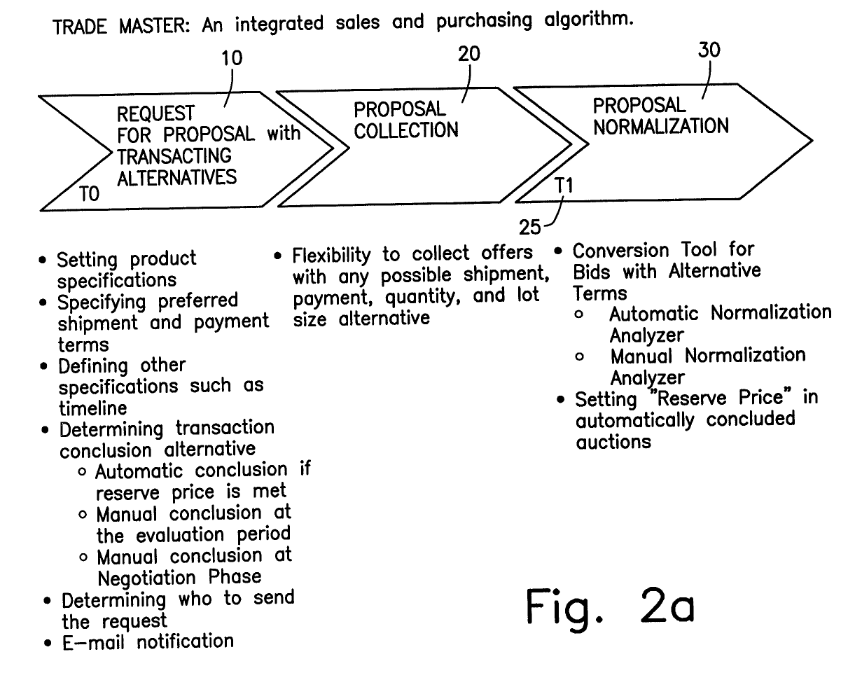

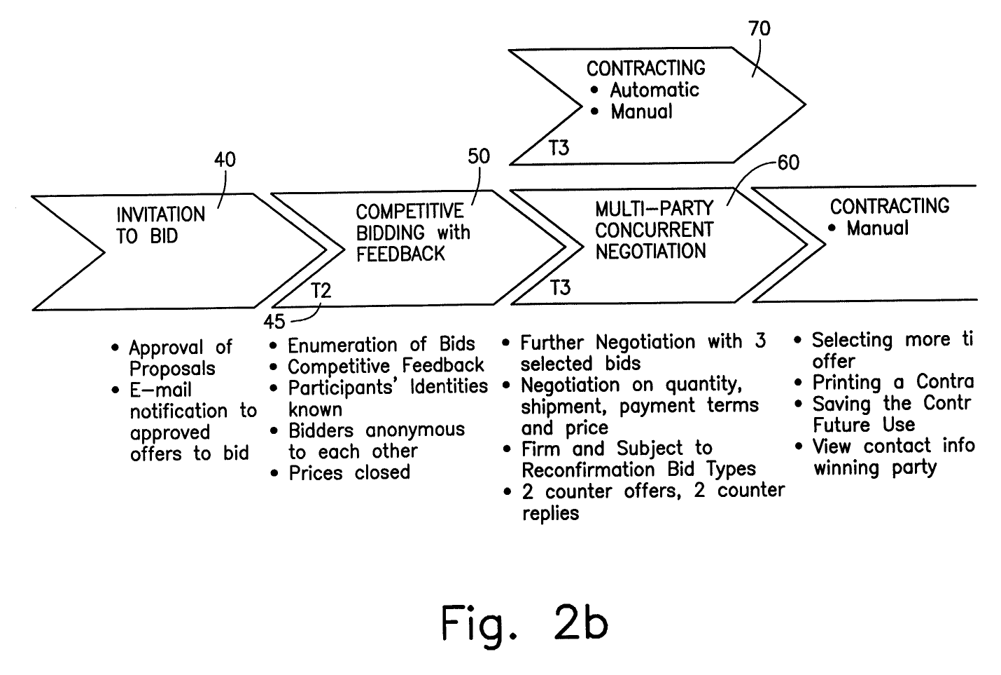

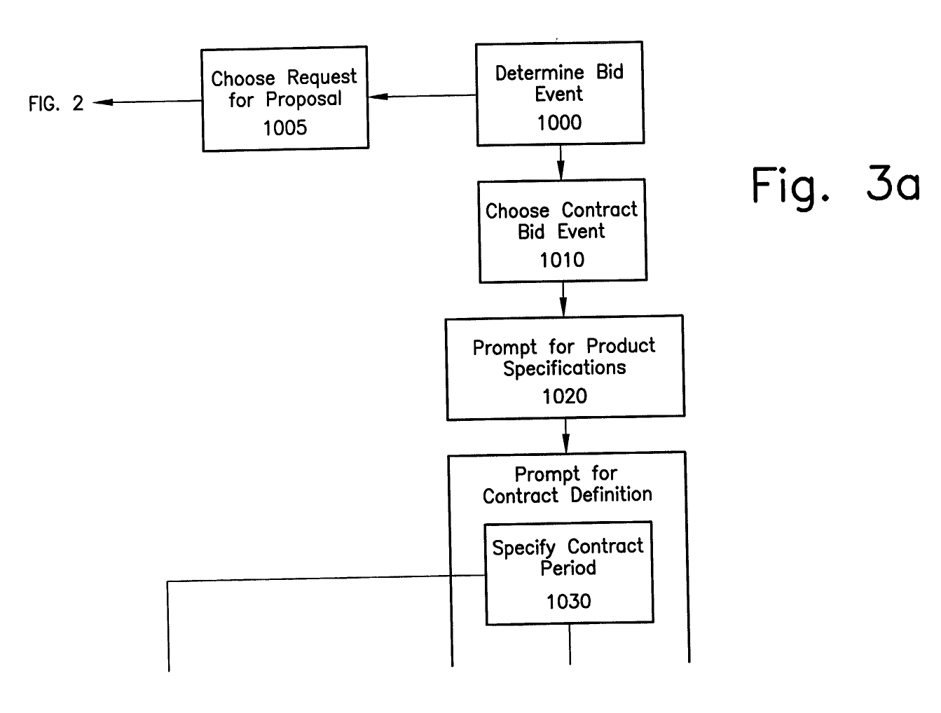

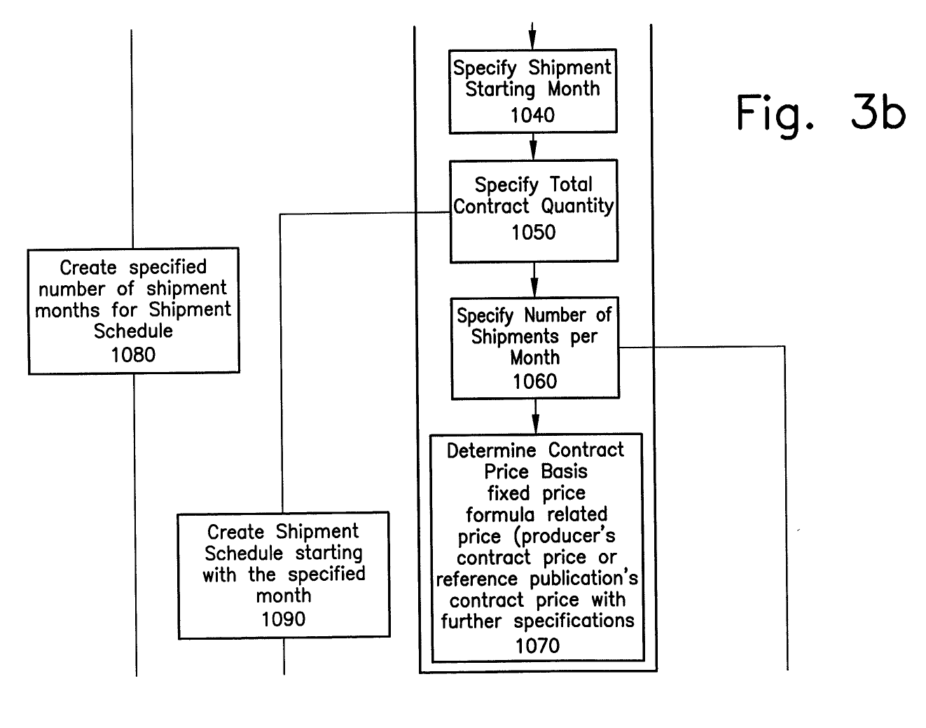

FIG. 2 shows a method for another embodiment according to the present invention. The first module 100 handles a request for proposal with transaction alternatives (Step 10), and also handles a proposal collection (Step 20). The second module 110 handles a Proposal Normalization (Step 30) and a Invitation to Bid (Step 40). The third module 120 handles a competitive bidding with feedback (Step 50). The fourth module 130 handles a multi-party concurrent negotiation (Step 60), a first contracting (Step 70), and a second contracting (Step 80).

During the request for proposal with transaction alternatives (Step 10), product specifications are defined; preferred shipment and payment terms, banks to work with, latest date to open L/C (letter of credit) are specified; other items, such as a timeline for the Bid Event, are specified; a transaction conclusion alternative is determined; who to send the request is defined; and e-mail notification is sent. Preferably, a transaction conclusion alternative can be set as determined by an automatic conclusion if a reserve price is met, a manual conclusion by the organizer at the evaluation period, or a manual conclusion at the end of a negotiation phase.

The product specifications may vary from one industry to another. However, specific to the steel industry, the product specifications can comprise terms for a Product Name, a Type, a Cast, a Grade a Quality, a Standard/Number/Grade, an Origin, a Producer, a Packing, a Quantity, a Quantity Tolerance, an Invoicing weight, a Size Breakdown, a Franchise, and a Notes on Product. Production limits/restrictions can also be present in the product specifications.

The payment terms can comprise terms for a Preferred Payment Terms, Banks the organizer works with, Earliest Date to Open L/C (letter of credit), Event Currency, Shipment/Delivery Date, Preferred Shipment Term, Destination, Load Rate, Discharge Rate, and Notes on Shipment. Moreover, a Bidding Starting Date, Bidding Starting Time, Bidding Closing Date, Bidding Closing Time, and Transaction Conclusion Alternative can also be defined. An evaluation Period could also be specified. Participants can also be specifically chosen. Preferably, a Transaction Conclusion Alternative term can be specified so that a transaction will be automatically concluded in favor of the best bid if the reserve price is met. If the reserve price isn't reached, then the organizer could conclude the bid event in favor of one or more bids during the evaluation period. The Transaction Conclusion Alternative term can also be specified so that the transaction will be concluded in favor of one or more bidders during the evaluation period by the organizer. The Transaction Conclusion Alternative term can be specified so that the transaction will be concluded at the negotiation platform in which the two best bids which are automatically selected by the system and one bid chosen by the organizer are present.

The organizer can set a term so that the price is closed to bidders throughout the bidding. Moreover, a participants Identity can be set so that parties are known, but bidders are anonymous to peers. In such a case, the identity of the Organizer will be known by all the bidders and an Organizer will know all the bidders' identities whereas the bidders will remain anonymous to one another throughout the bidding.

Once the above terms are finalized, the organizer views all the information entered on the Confirmation Page. On this page, the deadline for participants to send their proposals to the organizer is also stated. Preferably, the deadline is 24 hours before the bidding start.

During the proposal collection (Step 20), the invited participants are informed, for example, by e-mail and are notified of the deadline to send their proposals for the organizer's approval in order to participate in the bidding. The participant's proposal is shown below in Table 1. The proposal has a plurality of fields listed below, which can be viewed by clicking on the bid event number which is listed under ‘Invited Bid Events’ section. Preferably, the fields that are viewed differ between different products.

TABLE 1
You are required to send your proposal for the bid event detailed below by XXXX
(date) XXX (time). Those participants who have not provided their proposals by this
deadline cannot participate in and bid once the bidding starts.

| Auction Details | | Your Offer | Help |
|---|---|---|---|
| Product Name | XXXXXX | XXXXXXX | |
| Type | XXXXXX | can be changed | |
| | | (Free field) | |
| Cast | XXXXXX | can be changed | |
| | | (Free field) | |
| Grade | XXXXXX | can be changed | |
| | | (Free field) | |
| Quality | XXXXXX | can be changed | |
| | | (Free field) | |
| Standard/Number/ | XXXXXX | can be changed | |
| Grade | | (Free field) | |
| Origin: | Ukraine | can be changed | It's possible to offer products from origins other |
| | | (Combo box) | than the one(s) stated by the organizer. If you |
| | | | want to offer the same price for products with |
| | | | different origins, you may do so by chosing |
| | | | multiple origins with the CTRL key. |
| Producer | XXX | can be changed | Please state the names of producers for all the |
| | | (Free field) | origins specified. |
| Product | xxxxxxax | can be changed | |
| Specifications: | | (Free field) | |
| Packing: | XXXXXX | can be changed | |
| | | (Free field) | |
| Quantity: | XXXXX MT | can be changed | |
| | | (Free field) | |
| Quantity Tolerance: | + XXX MT | can be changed | |
| | | (Free field) | |
| Invoicing Weight: | Gerçek | can be changed | |
| | | (Combo Box) | |
| Size Breakdown: | 2.5 mm × | (Radio Butto) | Please make a choice. |
| | 5.5 mm 1000 MT | I can provide this | |
| | | breakdown. | |
| | | I can provide this | |
| | | breakdown in the | |
| | | following way: | |
| | | 2.5 mm × 6.0 mm | |
| | | 1200 MT | |
| Franchise | XXXXXXXX | can be changed | |
| | | (Free field) | |
| Notes on Order | XXXXXXXX | can be changed | |
| | | (Free field) | |
| Preferred Payment | XXXXXXXX | can be changed | |
| Terms: | | (Combo Box) | |
| Banks I Work with: | XXXXXXXX | can be changed | |
| | | (Free field) | |
| Earliest Date to | XXXXXXXX | can be changed | |
| Open L/C: | | | |
| Auction Currency: | Dollar | Dollar | |
| Shipment/Delivery | XXXXXXXX | can be changed | |
| Date: | | | |
| Preferred Shipment | XXXXXXXX | can be changed | |
| Term: | | (Combo Box) | |
| Destination | xxxxxxx | can be changed | |
| | | (Combo Box) | |
| Load/Discharge | XXXXXXXX | can be changed | |
| Rate: | | (Free Field) | |
| | | Specify | |
| | | Load/Discharge Rate | |
| | | if needed. | |
| Notes on Shipment | XXXXXX | can be changed | |
| | | (Free Field) | |

If the participant doesn't make any modifications on his side and clicks the “Send” button, the participant is considered to have accepted all the terms declared by the organizer. The participant may also make modifications to the terms on his side and click the “Send” button. In both cases, the participant may then view the Proposal Confirmation page where he/she may view the details of his proposal. The participant may then make changes by using “Edit” button, may cancel, or may save the proposal by using “Save for Later” button. Preferably, when the bid event number is clicked at a later time, the participant views his saved proposal(s) under “Proposals To Confirm.” If there are no saved proposals, this section will not be viewed.

The participant may also confirm the proposal by entering the Authorization Code and clicking on “Confirm”. Once “Confirm” is clicked, the participant can be informed that his proposal is sent for the organizer's approval. The participant can send more than one proposal to the organizer. If the participant has already sent one participant, he can send more by using a “Create New Proposal” button. When “Create New Proposal” is clicked, Table 1 is viewed once again. However, this time the participant views his earlier proposal under “Your Offer” section. He may again make necessary changes and hit “Send”. This process can be repeated.

If there are proposals already sent to the organizer's approval, when the bid event number is clicked, the participant views these proposals under “My Proposals”. If there is more than one proposal, they can be listed as Proposal 1, Proposal 2, etc. Preferably, the link on each proposal can be clicked, and the details of the proposal can be viewed with modifications made to the organizer's original highlighted in red.

Until a T1 25, the organizer can view the proposals sent by the participants under “Proposal to Approve”, but neither approve the proposal nor define the normalization value. The information that is provided can be: Participant Name, Product Origin, Quantity, Payment Terms, and a Shipment Term. If the link on each proposal is clicked, the details of the proposal can be viewed with the changes made to the organizer's terms. Preferably, this is highlighted in red.

The Proposal Normalization (Step 30) and Invitation to Bid (Step 40) comprise functionality for evaluating proposals which are different from the declared specifications in terms of cost differential. The cost can be calculated by the organizer and can be used to normalize and enumerate a plurality of bids during a bid event. Preferably to evaluate and normalize the proposal, the organizer clicks on the bid event number under “My Scheduled Events.” During Step 30, the organizer reviews each of the proposals and evaluates based on, for example, the product specifications, the product's quality, shipment term, payment term, shipment dates, his previous relationship with the participant making the proposal. Any difference between the proposal and the request denotes that there is a plus or minus cost for the organizer. Therefore the organizer assigns a cost value for each proposal. This value which will be defined in $/Euro terms will be added/subtracted from the original price entered by the bidder during the bidding. This way the organizer will be able to view on his screen the real price (e.g., converted price) of that particular offer. When entering normalization values for each proposal, the organizer may compare all the proposals with the terms stated in his request and assign a value or he may take one of the proposals (e.g., the one that he likes the most) as a reference and assign a value to each proposal by comparing it to the reference proposal.

Between T1 25 and a T2 45, the organizer specifies a normalization value for each proposal and also approves them. Preferably, the organizer makes his evaluation according to the following: the participant's product specifications and the effect this may have on the organizer's production, the participant's payment terms, the participant's shipment terms, the participant's product origin, and the financial capability and trust factor. The organizer can enter a positive or negative monetary amount (e.g., dollar, euro, etc) for the normalization value for each proposal.

The organizer can normalize the proposals and approve them at different times between T1 25 and T2 45. Normalization can be done by using a Manual Normalization Analyzer. The Manual Normalization Analyzer allows a user to enter data into a check box next to each proposal which is followed by a combo box with ±, then the currency, and finally by a free field box. The organizer checks the proposal that he wants to approve, then chooses plus or minus and enters the normalization value. He does this with one or more proposals, then enters the authorization code and approves the proposal. Approved proposals are viewed under a “Approved Proposals” section with the normalization value next to them. The normalization value can be changed until T2 45. Normalization can also be approved by approving each proposal from the page where the proposal details are viewed. In such a case, at the bottom of the page, a field, for example, called “Normalization value to use for normalization” is followed by a combo box with ±, then the event currency, and finally a free field box. The organizer chooses plus or minus and enters the normalization value. He then enters the authorization code and approves it. He can then view the approved proposal under “Approved Proposals” section with the normalization value next to it. As before, the normalization value can be changed until T2 45. Preferably, the organizer can specify whether the normalization value specified by the organizer can be viewed in full or in part by the bidders.

Normalization can also be done by using Automatic Normalization Analyzer. The Automatic Normalization Analyzer allows the organizer to specify product, delivery/shipment, payment, packing, surveying related costs all at once for as many terms as he wants. In Automatic Normalization the costs are the same for every bidder so that the organizer doesn't have to enter costs for each proposal every time. The system will calculate the cost automatically according to the values entered. Preferably, as above, the organizer can specify whether the normalization value specified by the organizer can be viewed in full or in part by the bidders.

Preferably, in order for the proposal to be considered as approved, a normalization value is specified. If the organizer has chosen “Automatic Transaction Conclusion”, then a “Converted Reserve Price” under the “Approved Proposals” section are entered before the bidding starts. Proposals, which are approved by the organizer and whose normalization values are specified, are then allowed to participate in the bid event.

The competitive bidding with feedback, Step 50, starts at T2 45. The bidders whose proposals are approved by the organizer can view the bid event under “Bid Events I Participate” and may place their price by clicking on a bid event number.

When the transaction is selected to be automatically concluded by the system, the organizer enters a converted reserve price during proposal normalization. The bids are enumerated by taking into account the normalization values assigned to each proposal during the bid event. The bids meeting or below the reserve price are, preferably, highlighted with a color. Bidders can see and place prices for their bids already approved by the organizer. Preferably, they can also fill out a price field. If a bidder has more than one approved bids, he can first select his bid from “Bid To Place Price”. When he chooses the bid, the following fields are filled by the system or the user according to the details of this particular bid: Product Origin, Producer, Quantity, Payment Terms, Shipment Term, and Price. The price field can be filled by the bidder. Preferably, there is also a link to other details of the bid.

The system displays an Organizer's Screen to the organizer. The organizer's screen comprises the following information: Quantity, Price, Normalization value, Origin, Payment Terms, Shipment Term, converted Price, Previous Bids, and Bid Details. The system also displays a bidder's Screen to each bidder. The bidder's screen comprises a Quantity, a Price, an Origin, a plurality of Payment Terms, a Shipment Term, a plurality of Previous Bids, and the Bid Details. A flag can be set so that Normalization Value and Converted Price can be viewed by the bidders only if the organizer states so.

Bidders may bid as often as they like during the bid event. The best bidder is selected as the winner of the bid event if he has met the reserve price at the end of the auction. If the reserve price is not met, then the organizer can conclude the transaction in favor of one or more bidders during the evaluation period. He may also choose not to conclude.

When the transaction is concluded by the Organizer, the bids can be enumerated by the system according to the prices placed and the normalization values specified for each bid. The bidder with the best bid is notified of his situation on his screen with a highlight. Bidders can see and place prices for their bids already approved by the organizer. When the bidder submits the bid, the following fields will be filled by the system according to the details of this particular bid, if the bidder so selects: Product Origin, Producer, Quantity, Payment Terms, Shipment Term, and Price. The price field can be entered by the bidder. Preferably, there is also a link to other details of the bid.

The system displays an Organizer's Screen to the organizer. The organizer's screen comprises: Bidders, Quantity, Price, Normalization value, Origin, Payment Terms, Shipment Terms, Converted Price, Previous Bids, and Bid Details. A bidder screen is also shown to the bidder. The Bidder's Screen comprises fields for Quantity, Price, Origin, Payment Terms, Shipment Term, Previous Bids and Bid Details. Normalization Value and Converted Price can be viewed by the bidders if the organizer states so. Preferably, bidders can bid as much as they like during the bid event. The organizer can conclude the transaction in favor of one or more bidders during the evaluation period. The organizer may also choose not to conclude.

When transaction is concluded by the Organizer during or After Multi-Party Concurrent Negotiation, at the end of the bidding, the two best bids automatically qualify to participate in a negotiation phase. Within 30 minutes after the end of the bidding, the organizer can select one more bid for the negotiation phase. If not, the negotiation phase starts with the other two bids. The bidders participating in the negotiation phase are notified and are informed about which of their bids is subject to negotiation on their screen. The organizer initiates the negotiation phase by sending counters to invited bids. At least one of these offers can be a “Firm Offer”. The first counter offers are sent by the organizer within 20 minutes of the start of the negotiation phase. If no counter offer is made within the specified time, the evaluation period will start automatically. There are two types of offers: a Firm Offer and a offer subject to reconfirmation. The organizer may make a Firm Counter Offer to the invited parties. A Firm Counter Offer is binding if accepted by the bidder. In an Offer Subject to Re-confirmation, the organizer may make offers to invited bidders which are subject to re-confirmation by the organizer. For the transaction to be concluded and the terms of the offer to be binding for both sides, this type of offer is confirmed once again by the organizer.

In the multi-party concurrent negotiation, Step 60, a Quantity, Price, Payment Terms, and Shipment Terms are used. There is also a Comment section for parties to enter their comments, if any. Preferably, The Negotiation Phase is 1.5 hours and comprises a first Counter Offer phase(0-20^{th} minute), a 1st Reply (21-50th minute),a 2nd Counter Offer (51-70th minute), and a 2nd Reply (71-90th minute). Preferably, the latest status of an offer may be viewed under “Status Monitoring” section. In certain embodiments of the present invention, the bidder receiving a “Firm Counter Offer” or a “Counter Offer Subject to Re-confirmation.” The bidder may accept this offer, change it or repeat his last offer. The organizer can re-approve a counter offer which is subject to re-confirmation for the offer to be binding, even though the counter offer is accepted by the bidder. Preferably, the negotiation phase can be concluded by the organizer at any time during the negotiation phase. If the organizer doesn't conclude a transaction during the negotiation phase, an evaluation period of 1 hour after the end of the negotiation phase can be given.

A transaction can be concluded in the negotiation phase when the bidder accepts a firm offer by the organizer by the bidder. For an offer subject to re-confirmation to be concluded, it is re-confirmed by the organizer after acceptance by the bidder. The bidder's acceptance alone does not result in the conclusion of the transaction. In both of the above cases, the organizer may continue to negotiate with the remaining bidder(s). If the organizer prefers to end the negotiation phase, he can do so by clicking on the “Conclude” button at the bottom of the page. In that case, offers accepted during the negotiation phase appear with an unchangeable symbol next to them. The organizer may also choose additional offers if he wants. Once the selection is complete, he enters the Authorization Code and presses a “Send” button to finish the process.

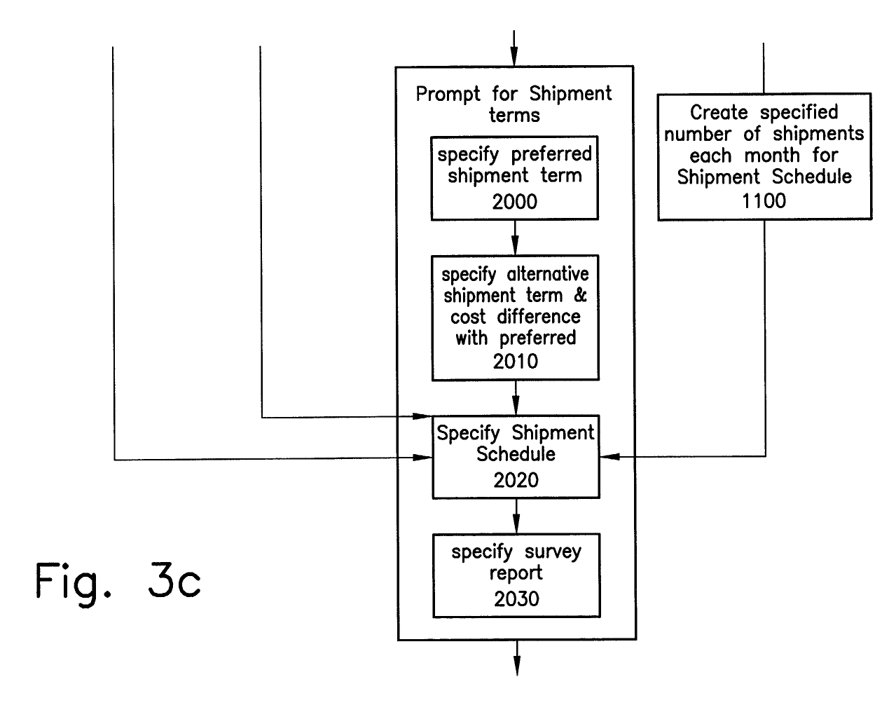

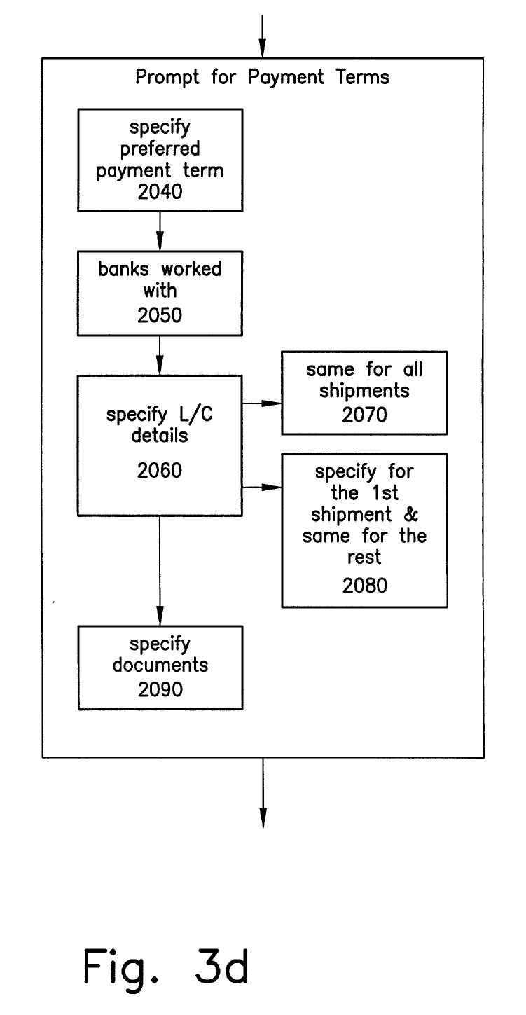

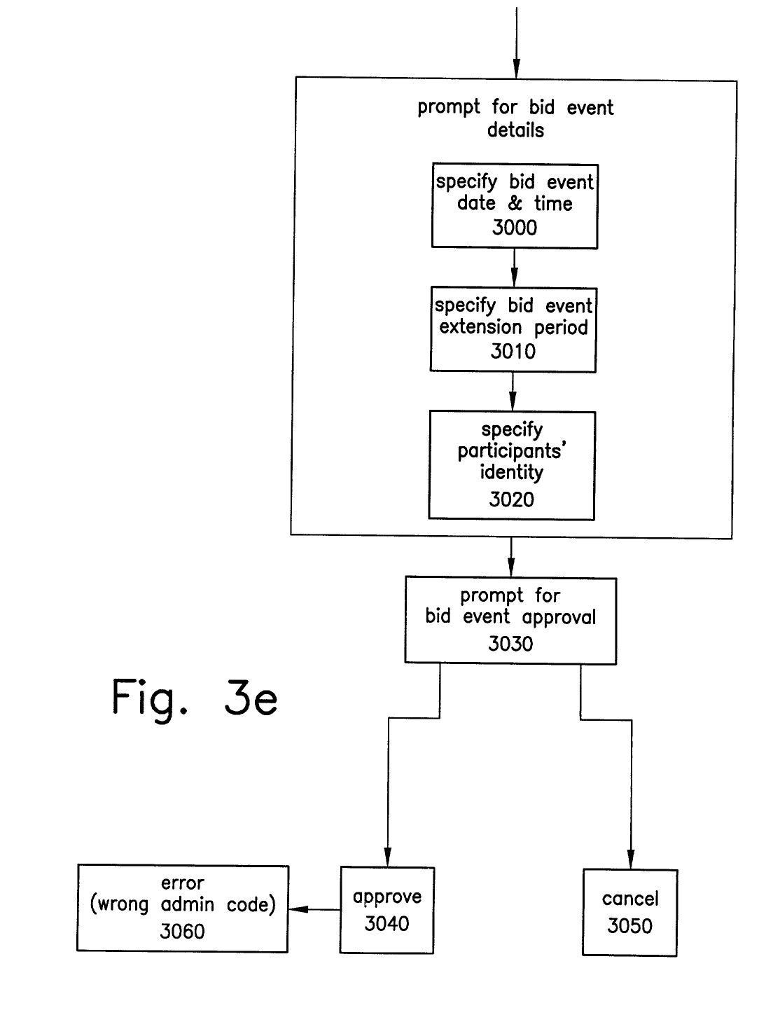

FIG. 3 shows the bidding process for the contract Bid Event.

A Bid Event is determined (Step 1000). The Bid Eevent can be chosen as a Request for Proposal or TradeMaster (Step 1005), in which case the invention proceeds as shown in FIG. 2. An auction can also be chosen as a Bid Event for contract purchases, in which case a contract bid event is then determined (Step 1010).

Product specifications for the bid event are defined (Step 1020). Preferably, for the steel industry the product specifications can include terms for a Product Name, a Type, a Cast, a Grade a Quality, a Standard/Number/Grade, a Origin a Producer, a Product Specifications, a Packing, a Quantity, a Quantity Tolerance, an Invoicing weight, a Size Breakdown, a Franchise, and a Notes on Product (Production limits/restrictions can also be mentioned). However, it should be understood that product specifications may vary for other industries.

The contract is then defined by a contract definition module. Preferably, the contract is defined by the following steps. A contract period is specified (Step 1030). Preferably, the contract period is between 2 and 12 months. A shipment starting month is specified (Step 1040). A Total contract quantity is specified (Step 1050). The number of shipments per month is also specified (Step 1060). Also, a contract price basis is determined (Step 1070). Preferably, when the contract period is specified (Step 1030), the shipment terms module (defined below) can be prompted to create a number of shipment months for a shipment schedule (Step 1080). Likewise, when the contract quantity is specified (Step 1050), the shipment terms module (defined below) can be prompted to create a shipment schedule starting with a specified month (Step 1090). Also, when the number of shipments per month is specified (Step 1060), the shipment terms module (defined below) can be prompted to create a specified number of shipments each month for a shipment schedule (Step 1100). Preferably, the contract price basis can be set as a fixed price or formula related price, with a reference to a price stated in a publication with further specifications or a reference to a price declared or to be declared by a producer with further specifications.

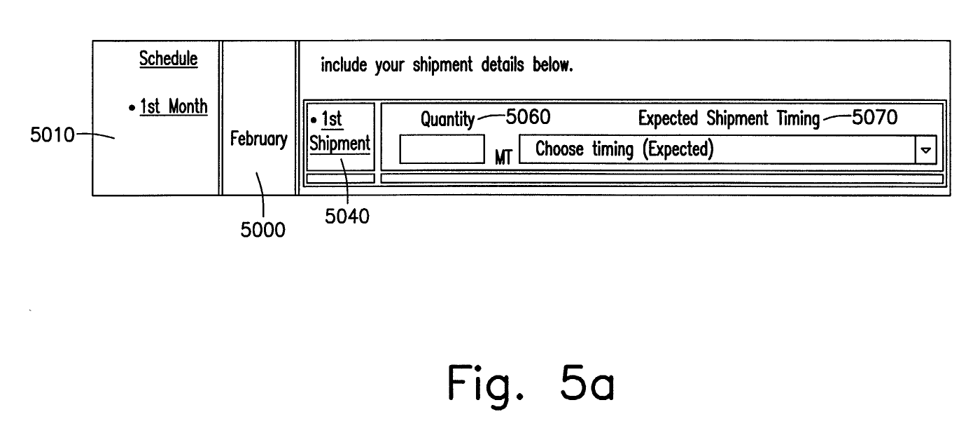

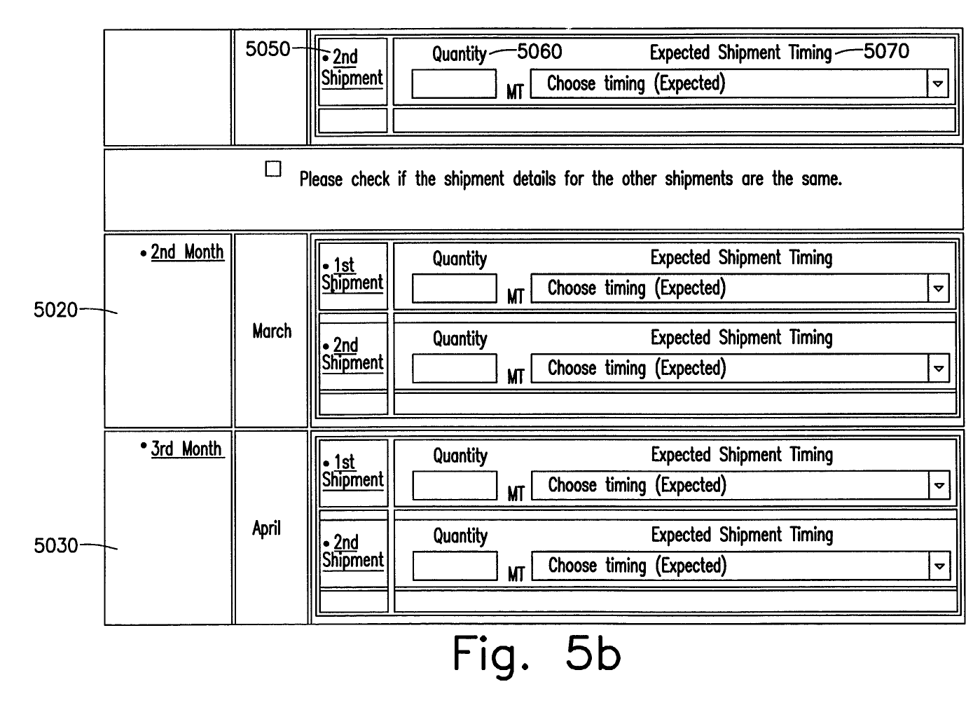

Next, a plurality of shipment terms are defined by a shipment terms module. Preferably, the shipment terms are defined by the following steps. A preferred shipment term is specified (Step 2000). An alternative shipment term with a cost difference with the preferred is also specified (Step 2010). A shipment schedule is then specified (Step 2020). A survey report is then specified (Step 2030). The shipment terms module automatically creates entries to specify details for each contract month and number of shipments within a month. For example, if the contract starting month was selected as February, the contract period was 3 months, and two shipments per month were specified, a screen that displays each shipment in each month, starting with February, is shown. An exemplary screen displaying this is shown in FIG. 5. The organizer then fills out each field.

A plurality of payment terms are then defined by a module. The payment terms are defined by the following steps. A preferred payment term is specified (Step 2040). One or more banking institutions are selected (Step 2050). L/C (letter of credit) details are specified (Step 2060). The L/C details can include a same for all shipments specification (Step 2070). The L/C details can also include a specification for the 1 st shipment and the same for the rest (Step 2080). A plurality of documents can also be specified (Step 2090).

Preferably, a variety of payment terms and shipment terms are used in the above modules. For example, Preferred Payment Terms, Banks the user works with, Earliest Date to Open L/C, Bid Event Currency, Shipment/Delivery Date, Preferred Shipment Term, Destination, Load Rate (can be if the shipment term is FOB or similar), Discharge Rate (can be activated if the shipment term is CIF or similar), and Notes on Shipment can be defined. Moreover, a Bidding Starting Date, Bidding Starting Time, Bidding Closing Date, Bidding Closing Time, bidding extension period, participants identities can also be defined.

Preferably, a term can be specified so that a transaction is automatically concluded in favor of the best bid if the reserve price is met. If the reserve price isn't reached, then the organizer can conclude the auction in favor of one or more bids during the evaluation period. A term can also be specified so that the transaction can be concluded in favor of one or more bidders during the evaluation period by the organizer. A term can be specified so that the transaction can be concluded at the negotiation platform in which the two best bids which are automatically selected by the system and one bid chosen by the organizer be present. An evaluation Period could also be specified. Specific sellers that can participate can also be specified.

A plurality of bid event details are then defined by a module. A Bid Event time and date is specified (Step 3000). A bid event extension period is specified (Step 3010). A participant's identity is also specified (Step 3020).

A module then checks for bid event approval (Step 3030). The organizer can then select to either approve the Bid Event (Step 3040) or cancel the bid event (Step 3050). If the bid event is approved (Step 3040), an error is produced (Step 3060).

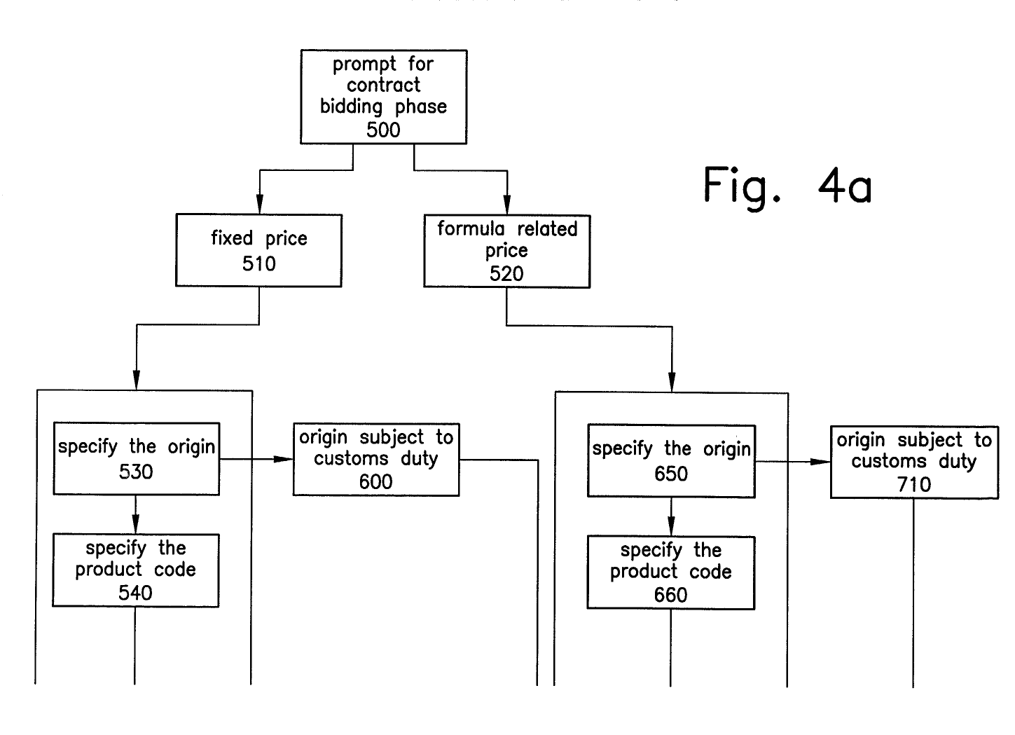

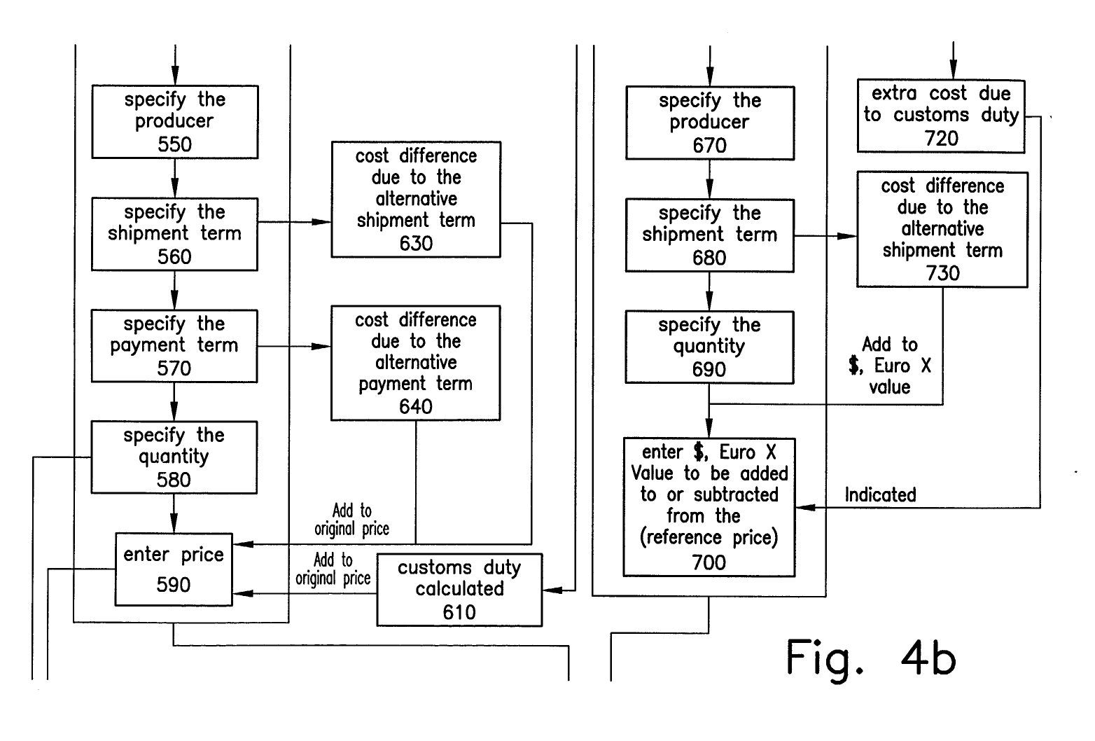

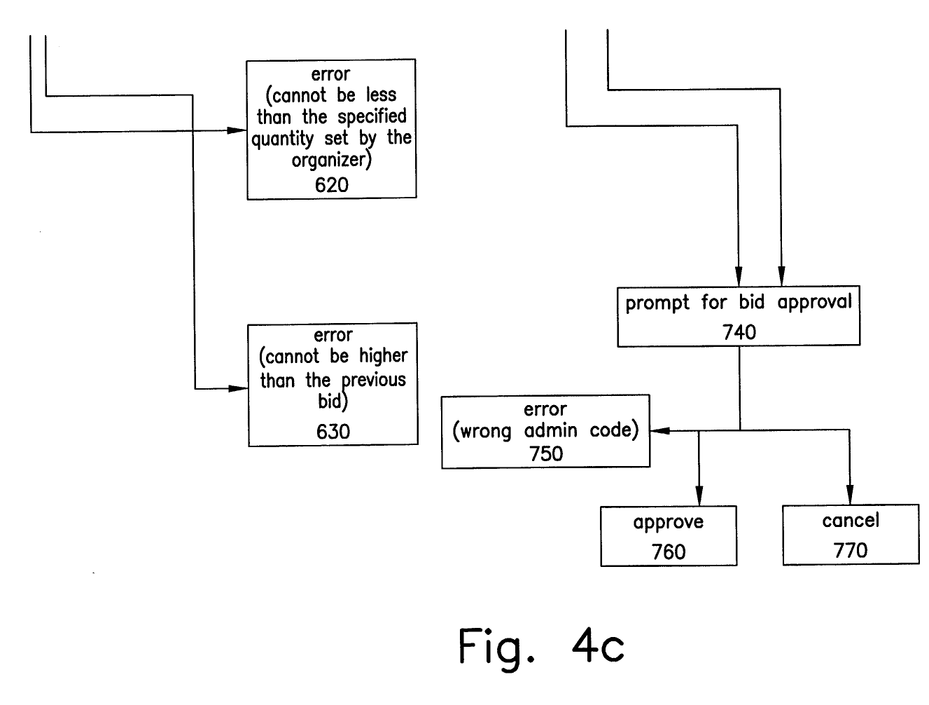

FIG. 4 shows a flow chart for the creation of the Bid Event for contract purchases.

A prompt for the contract bidding phase is issued (Step 500). A fixed price (Step 510) or a formula related price (Step 520) is then selected. If a fixed price (Step 510) was selected, an origin (Step 530), product code (Step 540), producer (Step 550), shipment term (Step 560), payment term (Step 570), quantity (Step 580), and/or price (Step 590) are specified. If the origin specified (Step 530) is subject to a customs duty (Step 600), a customs duty is calculated (Step 610) and added to the price when it is specified in Step 590. Moreover, if the shipment term that is specified (Step 560) results in a cost difference due to any alternative shipment terms, the cost difference is calculated (Step 630), and added to the price when it is specified in Step 590. Also, if the payment term that is specified (Step 570) results in a cost difference due to any alternative payment terms, the cost difference is calculated (Step 640), and added to the price when it is specified in Step 590. If the quantity is specified (Step 580) at more than the specified quantity set by the organizer, a first error (Step 620) is generated. If the price is specified (Step 590) at more than the previous bids, a first error (Step 630) is generated.

However, if a formula related price was selected (Step 520), an origin (Step 650), product code (Step 660), producer (Step 670), shipment term (Step 680), quantity (Step 690), and/or a price modification (Step 700) are specified. If the origin specified (Step 650) is subject to a customs duty (Step 710), extra costs due to the customs duty are calculated (Step 720) and added to the price when it is specified in Step 700. Moreover, if the shipment term that is specified (Step 680) results in a cost difference due to any alternative shipment terms, the cost difference is calculated (Step 730), and added to the price when it is specified in Step 700.

Next, a prompt for bid approval (Step 740) is issued. Depending on the response to the prompt, a third error (Step 750) is issued, the bid is approved (Step 760), or the bid is cancelled (Step 770).

FIG. 5 shows the shipment terms display screen. A contract starting month 5000 is shown. Also shown are a first, second, and third contract month (starting month) 5010,5020,5030. In each contract month are a first and second shipment field 5040,5050. In each of the first and second shipment fields are a quantity 5060 and an expected shipment timing 5070.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A computerized method for auctioning products or services, comprising the steps of:
sending a request, from an organizer, the request comprising one or more product specification terms, quantity terms, shipment terms, and payment terms;
in response to the request, receiving one or more proposals, each proposal comprising the shipment terms, quantity terms, and payment terms;
converting the received shipment terms, quantity terms, and payment terms into a normalized shipment term, quantity term, and payment term, respectively;
based on the normalized shipment term, quantity term, and payment term, accepting a plurality of bids from one or more bidders; and
selecting one or more of the bids.

2. The method as recited in claim 1 wherein the step of selecting one of the bids further comprises the steps of:
selecting three or less bidders based on the bids;
sending a counter-offer to each of the bidders, the counter-offer comprising the shipment terms, quantity terms, payment terms, and a price; and
receiving a counter-reply, the counter-reply comprising the shipment terms, quantity terms, payment terms, and the price.

3. The method as recited in claim 2 further comprising the step of repeating the steps of sending and receiving.

4. The method as recited in claim 1 further comprising the step of sending a bid notification to the one or more bidders, the step of sending located before the accepting step and after the converting step.

5. The method as recited in claim 1 wherein the steps of sending and receiving are performed by a first module, the step of converting is performed by a second module; the step of accepting is performed by a third module; and the step of selecting is performed by a fourth module.

6. The method as recited in claim 1 wherein the product specification is a steel product.

7. The method as recited in claim 1 wherein the product specification is a product used to manufacture steel.

8. The method as recited in claim 1 wherein the bidders are participants.

9. The method as recited in claim 1 wherein the step of converting is performed by a organizer.

10. The method as recited in claim 1 wherein the step of converting further comprises adding or subtracting a value from each of the proposals based on a product specification.

11. The method as recited in claim 1 wherein the step of converting further comprises adding or subtracting a value from each of the proposals based on a quality level of a product.

12. The method as recited in claim 1 wherein the step of converting further comprises adding or subtracting a value from each of the proposals based on a shipment date.

13. The method as recited in claim 1 wherein the step of converting further comprises adding or subtracting a value from each of the proposals based on a prior relationship with the bidder.

14. The method as recited in claim 1 wherein the step of converting further comprises adding or subtracting a value from each of the proposals based on a quantity of the a product.

15. The method as recited in claim 1 wherein the step of converting further comprises adding or subtracting a value from each of the proposals based on a payment term.

16. The method as recited in claim 15 wherein the payment term is credit.

17. The method as recited in claim 15 wherein the payment term is cash on delivery.

18. The method as recited in claim 1 wherein the step of converting is performed by an organizer.

19. The method as recited in claim 1 wherein the step of converting further comprises adding or subtracting Euros from a price.

20. The method as recited in claim 1 wherein the step of converting further comprises adding or subtracting U.S. dollars from a price.

21. A system comprising four modules:
a first module comprising functionality of:
sending a request, from an organizer, the request comprising one or more product specification terms, quantity terms, shipment terms, and payment terms;
in response to the request, receiving one or more proposals, each proposal comprising the shipment terms, quantity terms, and payment terms;
a second module comprising functionality of:
converting the received shipment terms, quantity terms, and payment terms into a normalized shipment term, quantity term, and payment term, respectively;
sending a bid notification to one or more bidders;
a third module comprising functionality of:
based on the normalized shipment term, quantity term, and payment term, accepting a plurality of bids from one or more bidders;
a fourth module comprising functionality of:
selecting three or less bidders based on the bids;
sending a counter-offer to each of the bidders, the counter-offer comprising the shipment terms, quantity terms, payment terms, and a price; and
receiving a counter-reply from each of the bidders, the counter-reply comprising the shipment terms, quantity terms, payment terms, and price; and
and selecting one or more of the counter-replies.

22. A method for auctioning products or services, comprising the steps of:
specifying a shipment schedule, the shipment schedule comprising a starting date, an ending date, and a time period for a plurality fo shipments;
displaying each of the shipments based on the starting date, ending date, and time period; and
displaying a quantity field and an expected time field for each of the shipments, the quantity field and expected time field configurable by a user.

23. A computerized method for auctioning products or services, comprising the steps of:
sending a request, from an organizer, the request comprising one or more product specification terms, quantity terms, shipment terms, payment terms other terms that are relevant to the organizer's line of business or practices;
in response to the request, receiving one or more proposals, each proposal comprising the product specifications, shipment terms, quantity terms, payment terms and other terms that are relevant to the organizer's line of business or practices;
converting the received shipment terms, quantity terms, and payment terms into a normalized shipment term, quantity term, and payment term, respectively;
based on the normalized shipment term, quantity term, and payment term, accepting a plurality of bids from one or more bidders; and
selecting one or more of the bids.

24. The method as recited in claim 1 wherein the step of selecting one of the bids further comprises the steps of:
selecting three or less bidders based on the bids;
sending a firm or subject to re-confirmation counter-offer to each of the bidders, the counter-offer taking place within a specified time and comprising the shipment terms, quantity terms, payment terms, and a price;
receiving a firm counter-reply, the counter-reply taking place within a specified time and comprising the shipment terms, quantity terms, payment terms, and the price.

25. A method for auctioning products or services, comprising the steps of:
specifying a plurality of contract terms, the contract terms comprising a contract duration, a contract starting month, a total contract quantity, a number of shipments per month, a contract price basis, the contract price basis based on a fixed price or a formulate related price with reference to a publication or producer with further specifications;
specifying a shipment schedule, the shipment schedule comprising a shipment month, and a number of shipments within the month;
displaying each of the shipments based on the shipment month and the number of shipments within the month;
displaying a quantity per shipment field and an expected shipment timing field for each of the shipments, the quantity per shipment field and the expected shipment timing field configurable by a user;
bidding for a fixed contract price or a formula related price based on a formula, the formula specified as a reference to a publication or a producer with further specifications; and
providing feedback to the bidders when a price information is closed.
